(19) United States
(12) Patent Application Publication
(10) Pub. No.: US 2021/0356569 A1
(43) Pub. Date: Nov. 18, 2021

(54) DISTANCE MEASUREMENT APPARATUS AND DETECTION METHOD

(71) Applicant: SONY SEMICONDUCTOR SOLUTIONS CORPORATION, KANAGAWA (JP)

(72) Inventor: SHUNJI MAEDA, KANAGAWA (JP)

(21) Appl. No.: 17/281,139

(22) PCT Filed: Sep. 25, 2019
(86) PCT No.: PCT/JP2019/037453

§ 371 Date: Mar. 29, 2021

(30) Foreign Application Priority Data
Oct. 9, 2018 (JP) 2018-190642

(51) Int. Cl. G01S 7/497; G01S 7/481; G01S 7/4865; G01S 17/931; G01S 7/484; G01S 17/894

(52) U.S. Cl. CPC G01S 7/497; G01S 7/4814; G01S 17/894; G01S 17/931; G01S 7/484; G01S 7/4865

(57) ABSTRACT

The present disclosure relates to a distance measurement apparatus and a detection method that allow for reliable detection of diffuser breakage. Provided is a distance measurement apparatus that includes a light source section and a breakage detection section. The light source section emits a laser beam. The breakage detection section detects breakage of a diffusion member that diffuses the laser beam emitted from the light source section. The light source section modulates the laser beam on the basis of a pulsed wave generated by a pulse generator and emits the modulated laser beam. The breakage detection section feeds the pulsed wave to one end of a transparent electrode formed in a predetermined pattern on the diffusion member, detects a reflected wave that occurs at a released end that is another end, and detects breakage of the diffusion member on the basis of a detection result of the reflected wave. The technology according to the present disclosure is applicable, for example, to a distance image sensor using a TOF technique.

### TECHNICAL FIELD

The present disclosure relates to a distance measurement apparatus and a detection method, and particularly, to a distance measurement apparatus and a detection method that allow for reliable detection of diffuser breakage.

### BACKGROUND ART

A distance measurement apparatus such as TOF (Time Of Flight) sensor diffuses a comparatively high output laser beam source for use. Here, in the case where the diffuser breaks, for example, as a result of the fall of the distance measurement apparatus, preventive measures are required to protect users from the laser beam.

For example, PTLs 1 and 2 disclose technologies for halting emission of a laser beam from a laser beam source in the event of detachment of a diffractive optical element.

### CITATION LIST

### Patent Literature

[PTL 1]

Japanese Patent Laid-Open No. 2014-085280

[PTL 2]

Japanese Patent Laid-Open No. 2014-190823

### SUMMARY

### Technical Problem

In order to protect users from a laser beam, it is necessary to reliably detect breakage of a diffuser, making technologies for reliably detecting diffuser breakage in demand.

The present disclosure has been devised in light of such circumstances, and it is an object of the present disclosure to allow for reliable detection of diffuser breakage.

### Solution to Problem

A distance measurement apparatus of an aspect of the present disclosure includes a light source section and a breakage detection section. The light source section emits a laser beam. The breakage detection section detects breakage of a diffusion member that diffuses the laser beam emitted from the light source section. The light source section modulates the laser beam on the basis of a pulsed wave generated by a pulse generator and emits the modulated laser beam. The breakage detection section feeds the pulsed wave to one end of a transparent electrode formed in a predetermined pattern on the diffusion member, detects a reflected wave that occurs at a released end that is another end, and detects breakage of the diffusion member on the basis of a detection result of the reflected wave.

A detection method of an aspect of the present disclosure is a detection method by a distance measurement apparatus including a light source section that emits a laser beam. The detection method includes feeding a pulsed wave generated by a pulse generator and used by the light source section to modulate the laser beam, to one end of a transparent electrode formed in a predetermined pattern on a diffusion member that diffuses the laser beam emitted from the light source section, detecting a reflected wave that occurs at a released end that is another end, and detecting breakage of the diffusion member on the basis of a detection result of the reflected wave.

In the distance measurement apparatus and the detection method of an aspect of the present disclosure, a pulsed wave, which is generated by a pulse generator and used by the light source section to modulate the laser beam, is fed to one end of a transparent electrode formed in a predetermined pattern on a diffusion member that diffuses the laser beam emitted from the light source section, a reflected wave that occurs at a released end that is another end is detected, and breakage of the diffusion member is detected on the basis of a detection result of the reflected wave.

A distance measurement apparatus of one aspect of the present disclosure includes a light source section and a breakage detection section. The light source section emits a laser beam. The breakage detection section detects breakage of a diffusion member that diffuses the laser beam emitted from the light source section. The breakage detection section feeds a pulsed wave generated by a pulse generator, to one end of a transparent electrode formed in a predetermined pattern on the diffusion member, detects a reflected wave that occurs at a released end that is another end, and detects breakage of the diffusion member on the basis of a detection result of the reflected wave.

A detection method of an aspect of the present disclosure is a detection method by a distance measurement apparatus including a light source section that emits a laser beam. The detection method includes feeding a pulsed wave generated by a pulse generator, to one end of a transparent electrode formed in a predetermined pattern on a diffusion member that diffuses the laser beam emitted from the light source section, detecting a reflected wave that occurs at a released end that is another end, and detecting breakage of the diffusion member on the basis of a detection result of the reflected wave.

In the distance measurement apparatus and the detection method of an aspect of the present disclosure, a pulsed wave generated by a pulse generator is fed to one end of a transparent electrode formed in a predetermined pattern on a diffusion member that diffuses a laser beam emitted from a light source section, a reflected wave that occurs at a released end that is another end is detected, and breakage of the diffusion member is detected on the basis of a detection result of the reflected wave.

A distance measurement apparatus of an aspect of the present disclosure includes a light source section, an optical detector, and a breakage detection section. The light source section emits a laser beam. The optical detector is provided at a predetermined position relative to a diffusion member that diffuses the laser beam emitted from the light source section and detects the laser beam that has passed through the diffusion member. The breakage detection section detects breakage of the diffusion member on the basis of a detection result by the optical detector.

A detection method of an aspect of the present disclosure includes detecting breakage of a diffusion member that diffuses a laser beam emitted from a light source section on the basis of a detection result by an optical detector that is provided at a predetermined position relative to the diffusion member to detect the laser beam that has passed through the diffusion member.

It should be noted that the distance measurement apparatus of an aspect of the present disclosure may be an independent apparatus or an internal block included in a single apparatus.

### BRIEF DESCRIPTION OF DRAWINGS

FIG. 1 is a block diagram illustrating a configuration example of a distance measurement apparatus to which the technology according to the present disclosure is applied.

FIG. 2 is a diagram illustrating a usage example of a diffuser.

FIG. 3 illustrates a first example of detection of diffuser breakage.

FIG. 4 illustrates a second example of detection of diffuser breakage.

FIG. 5 is a diagram illustrating a first example of detection of diffuser breakage by a distance measurement apparatus to which the technology according to the present disclosure is applied.

FIG. 6 depicts timing charts illustrating examples of detection results of a normal state and a broken state in the first example of detection of diffuser breakage.

FIG. 7 illustrates another first example of detection of diffuser breakage.

FIG. 8 is a diagram illustrating a second example of detection of diffuser breakage by the distance measurement apparatus to which the technology according to the present disclosure is applied.

FIG. 9 illustrates another second example of detection of diffuser breakage.

FIG. 10 is a diagram illustrating a third example of detection of diffuser breakage by the distance measurement apparatus to which the technology according to the present disclosure is applied.

FIG. 11 is a diagram illustrating another third example of detection of diffuser breakage.

FIG. 12 is a diagram illustrating a fourth example of detection of diffuser breakage by the distance measurement apparatus to which the technology according to the present disclosure is applied.

FIG. 13 is a diagram illustrating a fourth example of detection of diffuser breakage by the distance measurement apparatus to which the technology according to the present disclosure is applied.

FIG. 14 is a diagram illustrating another fourth example of detection of diffuser breakage.

FIG. 15 is a diagram illustrating a fifth example of detection of diffuser breakage by the distance measurement apparatus to which the technology according to the present disclosure is applied.

FIG. 16 is a diagram illustrating another fifth example of detection of diffuser breakage.

FIG. 17 is a block diagram illustrating a configuration example of electronic equipment having a distance measurement apparatus to which the technology according to the present disclosure is applied.

FIG. 18 is a block diagram depicting an example of schematic configuration of a vehicle control system.

FIG. 19 is a diagram of assistance in explaining an example of installation positions of an outside-vehicle information detecting section and an imaging section.

### DESCRIPTION OF EMBODIMENTS

A description will be given below of embodiments of the technology according to the present disclosure (present technology) with reference to drawings. It should be noted that the description will be given in the following order.
1. First Embodiment
2. Second Embodiment
3. Third Embodiment
4. Fourth Embodiment
5. Fifth Embodiment
6. Modification example
7. Configuration example of electronic equipment
8. Example of application to mobile object

### 1. First Embodiment

(Configuration Example of the Distance Measurement Apparatus)

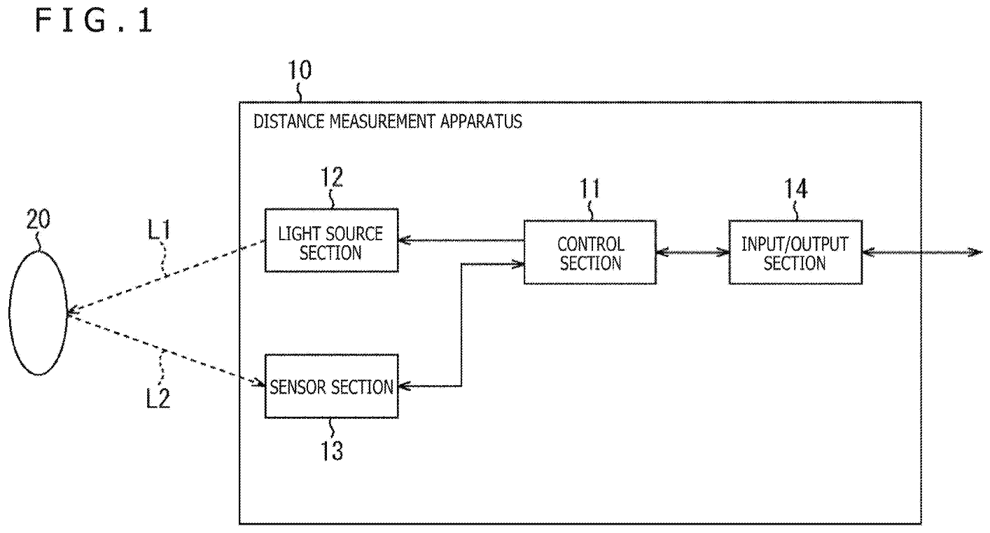

FIG. 1 is a block diagram illustrating a configuration example of a distance measurement apparatus to which the technology according to the present disclosure is applied.

A distance measurement apparatus 10 illustrated in FIG. 1 is configured, for example, as a distance image sensor using a TOF (Time Of Flight) technique.

In FIG. 1, the distance measurement apparatus 10 includes a control section 11, a light source section 12, a sensor section 13, and an input/output section 14.

The control section 11 includes, for example, a circuit section including a microcomputer and logic circuits and the like. The control section 11 functions as a key processing device of the distance measurement apparatus 10 by performing tasks such as controlling actions of different sections and handling various computations.

The light source section 12 irradiates light to a target object 20 under control of the control section 11. A device capable of fast modulation such as an LED (Light Emitting Diode) can be used as the light source section 12 to emit a modulated beam (rectangular pulsed beam) which is light modulated with a rectangular pulsed wave or the like (laser beam), and irradiate the light to the target object 20.

When light is irradiated to the target object 20 by the light source section 12, irradiated light L1 irradiated to the target object 20 is reflected according to a reflectance of the target object 20, causing reflected light S2 thereof to enter the sensor section 13 via a lens (not depicted).

The sensor section 13 includes, for example, a solid-state imaging element using a CMOS (Complementary Metal Oxide Semiconductor). This solid-state imaging element includes a plurality of pixels, each having a photoelectric conversion element, arranged two-dimensionally.

The control section 11 controls synchronization between the light source section 12 and the sensor section 13, and the sensor section 13 images the reflected light L2 from the target object 20 by performing a shutter operation under control of the control section 11, outputting an imaging result (amount of exposure) to the control section 11.

The control section 11 calculates, on the basis of the imaging results (amounts of exposure) from the sensor section 13, a ratio between the amounts of exposure proportional to the shutter operations, generating distance information (distance image) corresponding to the calculation result. Here, for example, when modulated light is irradiated to the target object 20, time required for reflected light to return varies depending on the position where the modulated light is irradiated. Accordingly, the time can be found by taking the ratio between the amounts of exposure which is each obtained at one of the first and second two consecutive shutter operations, thus generating distance information.

The input/output section 14 includes an input/output interface circuit that supports a predetermined technique and inputs or outputs data exchanged between the control section 11 and external apparatuses.

The distance measurement apparatus 10 configured as described above is a distance image sensor based on a TOF technique using modulated light modulated as a light source that adopts what is called an indirect technique.

Here, a direct technique is available as a TOF technique that measures a TOF in a direct time domain, and techniques other than such a direct technique are considered indirect techniques. In other words, it can be said that the indirect techniques achieve measurement by taking advantage of a change in TOF-dependent physical quantity and a time criterion by which to convert the change into a temporal change. It should be noted that, in the description given below, of the TOF distance measurement apparatuses 10, those based on the indirect techniques will be also referred to as the indirect distance measurement apparatuses 10.

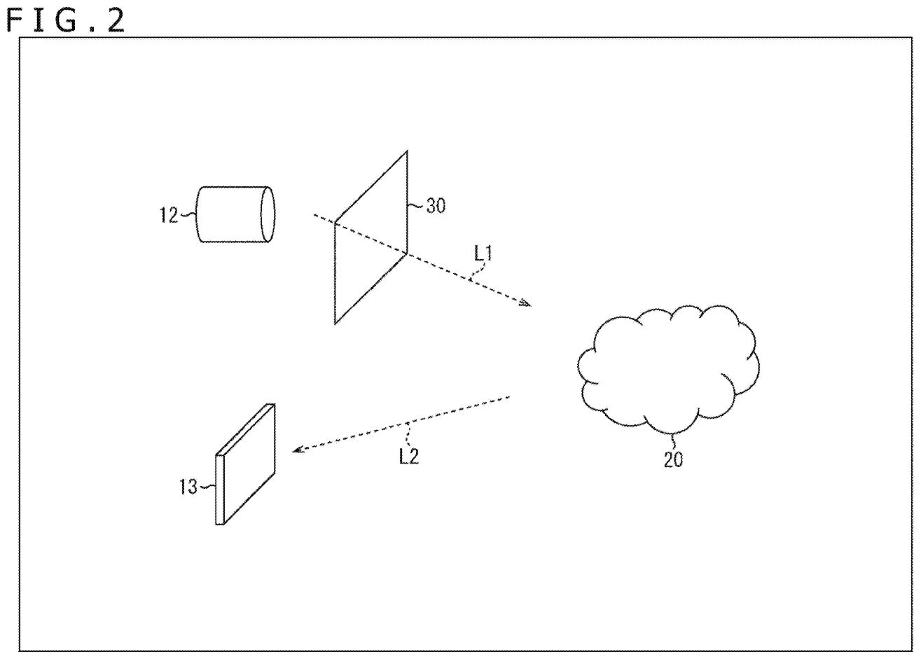

Also, an active distance image sensor like the TOF distance measurement apparatus 10 diffuses a laser beam from the light source section 12 with a diffuser 30 (FIG. 2). By using the diffuser 30, the distance measurement apparatus 10 can not only capture the target object 20 as a plane using a larger detection area but also ensure safety in laser beam use.

Accordingly, for example, in the case where the diffuser 30 breaks as a result of the fall of the distance measurement apparatus 10, there is a possibility that a laser beam from the light source section 12 may directly enter user's eyes, thus requiring some kind of detection means (detection method) to protect the user from the laser beam.

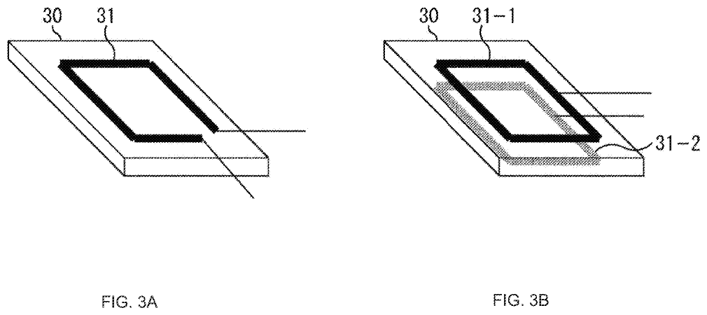

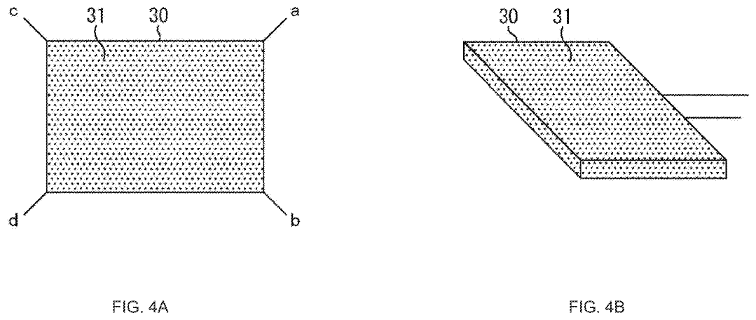

Detection means illustrated in FIGS. 3 and 4 is a possible example of means of detecting breakage of the diffuser 30 configured as described above.

Firstly, there is provided means of detecting breakage of the diffuser 30 by rectangularly applying a transparent electrode 31 to part of a region of at least one of a front or rear side of the diffuser 30 and detecting a change in resistance or capacitance thereof (FIG. 3).

FIG. 3A illustrates a case where the transparent electrode 31 is applied only to the front side of the diffuser 30. Also, FIG. 3B illustrates a case where transparent electrodes 31-1 and 31-2 are applied to the front and rear sides of the diffuser 30, respectively.

In the first detection means, only part of the region of the diffuser 30 is coated with the transparent electrode 31. As a result, while this suppresses a decline in laser beam intensity by the diffuser 30, it is impossible to detect breakage if the breakage occurs in a region other than that where the transparent electrode 31 functions as a detection line.

Secondly, there is provided means of detecting breakage of the diffuser 30 by applying the transparent electrode 31 over the entire region of at least one of the front or rear side of the diffuser 30 and detecting the change in resistance or capacitance thereof (FIG. 4).

FIG. 4A illustrates a case where the transparent electrode 31 is applied over the entire region of the front side of the diffuser 30. Sheet resistance can be found by passing a constant current between points a and b and measuring a potential difference between points c and d. Accordingly, it is possible to detect breakage of the diffuser 30 by detecting a value change in this sheet resistance.

Also, FIG. 4B illustrates a case where the transparent electrode 31 is applied over the entire regions of not only the front and rear sides of the diffuser 30 but also lateral sides thereof. It is possible to detect breakage of the diffuser 30 by detecting a change in capacitance thereof.

In the second detection means, the diffuser 30 is coated with the transparent electrode 31 over the entire region thereof. While this allows for detection of breakage of the diffuser 30 regardless of the location, the laser beam diminishes significantly in light intensity because of the diffuser 30.

As described above, although the above detection means permits detection of breakage of the diffuser 30, the detection is not possible if the diffuser 30 breaks at part where the transparent electrode 31 is not applied. Moreover, the application of the transparent electrode 31 over the entire surface of the diffuser 30 leads to reduced transmittance.

Accordingly, there has been a demand for a technology that allows for the distance measurement apparatus 10 to detect breakage of the diffuser 30 that diffuses a laser beam emitted from the light source section 12 regardless of the location without sacrificing the transmittance of the diffuser 30. Accordingly, the technology according to the present disclosure proposes a technology for reliably detecting breakage of the diffuser 30 without sacrificing the transmittance of the diffuser 30.

(Example of Detection of Diffuser Breakage)

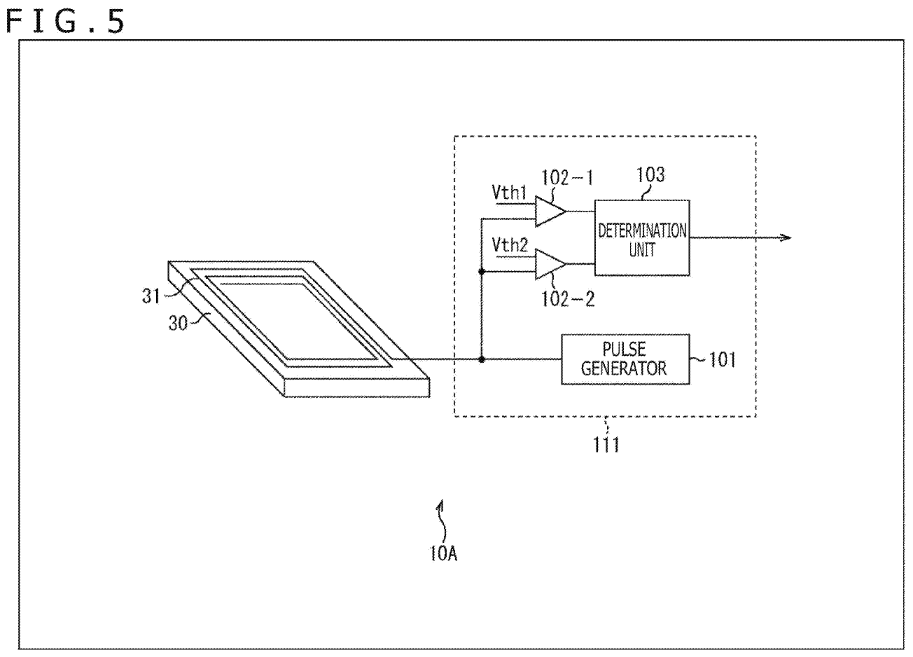

FIG. 5 is a diagram illustrating a first example of detection of diffuser breakage by a distance measurement apparatus to which the technology according to the present disclosure is applied.

In FIG. 5, a distance measurement apparatus 10A has the transparent electrode 31 and a breakage detection section 111 for the diffuser 30. The breakage detection section 111 includes a pulse generator 101, comparators 102-1 and 102-2, and a determination unit 103.

Here, the linear transparent electrode 31 is applied in a spiral form to a surface of the diffuser 30. The transparent electrode 31 has its one end connected to the pulse generator 101, to one input end of the comparator 102-1 and to one input end of the comparator 102-2, and its other end is left open on the diffuser 30.

The pulse generator 101 generates a rectangular pulsed wave (pulsed signal), feeding the rectangular pulsed wave to the transparent electrode 31 connected thereto. When fed to the transparent electrode 31, this rectangular pulsed wave is reflected at the open end, thus causing a reflected wave thereof to be captured by the comparators 102-1 and 102-2.

The comparator 102-1 has its one input end connected to the transparent electrode 31 and compares a voltage level of the input signal fed from the input end with a reference voltage Vth1 fed from its other input end, outputting a comparison result thereof (e.g., an H- or L-level signal) to the determination unit 103.

The comparator 102-2 has its one input end connected to the transparent electrode 31 and compares a voltage level of the input signal fed from the input end with a reference voltage Vth2 fed from its other input end, outputting a comparison result thereof (e.g., an H- or L-level signal) to the determination unit 103.

The determination unit 103 determines whether or not a determination condition for determining whether or not the diffuser 30 is broken is met on the basis of the first comparison result output from the comparator 102-1 and the second comparison result output from the comparator 102-2, outputting a determination result thereof.

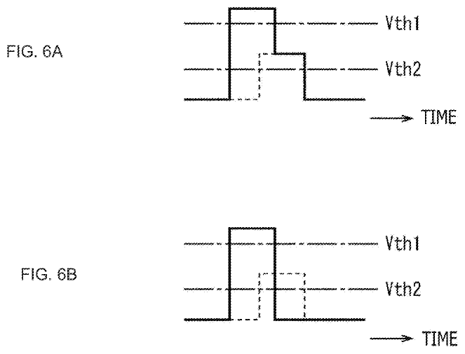

Here, the timing charts in FIG. 6 illustrate the voltage levels to be compared in a normal state and a broken state. It should be noted that, in FIG. 6, a time direction is from the left to the right in the figure.

As illustrated in FIG. 6A, a reflected wave is fed from the open end of the transparent electrode 31 formed on the surface of the unbroken diffuser 30 in a normal state, thus causing a rectangular pulsed wave and its reflected wave to be combined (superimposed one on another) and producing a stepwise wave.

At this time, the comparator 102-1 compares the voltage level of the input signal with the reference voltage Vth1 set between the voltage level of the pulsed wave (rectangular pulsed wave) and the voltage level of the reflected wave, outputting a comparison result corresponding to the rectangular pulsed wave to the determination unit 103.

Also, the comparator 102-2 compares the voltage level of the input signal with the reference voltage Vth2 set equal to or less than the voltage level of the reflected wave (reflected pulsed wave), outputting a comparison result corresponding to the reflected wave part of which overlaps the pulsed wave to the determination unit 103.

Then, the determination unit 103 measures a time difference between falling edges of the input signals compared on the basis of the comparison results from the comparators 102-1 and 102-2, i.e., a time difference between the falling edge of the pulsed wave and the falling edge of the reflected wave, determining whether or not the time difference is equal to or smaller than a predetermined threshold. In FIG. 6A, the time difference between the falling edges exceeds the predetermined threshold. Accordingly, the determination unit 103 determines that the diffuser 30 is in a normal state, outputting a determination result to that effect.

Meanwhile, as illustrated in FIG. 6B, in a broken state, a reflected wave is fed from the open end of the transparent electrode 31 formed on the broken diffuser 30 (the length is short to the open end), changing a timewise position of the reflected wave relative to the pulsed wave and producing a rectangular wave.

At this time, the comparator 102-1 compares the voltage level of the input signal with the reference voltage Vth1, outputting a comparison result corresponding to the rectangular pulsed wave to the determination unit 103. Also, the comparator 102-2 compares the voltage level of the input signal with the reference voltage Vth1, outputting a comparison result corresponding to the reflected wave all of which overlaps the pulsed wave to the determination unit 103.

Then, the determination unit 103 measures a time difference between falling edges of the input signals compared on the basis of the comparison results from the comparators 102-1 and 102-2. Here, the pulsed wave includes the reflected wave, causing the time difference between the falling edges to be equal to or smaller than the predetermined threshold. As a result, the determination unit 103 determines that the diffuser 30 is broken, outputting a determination result to that effect.

As described above, in the first example, a pulsed wave is fed to the transparent electrode 31 after the transparent electrode 31 has been applied in a spiral form to the diffuser 30. As a result, the temporal position of the reflected wave changes in the case where the diffuser 30 is broken. Accordingly, it is possible to reliably detect the breakage of the diffuser 30 by detecting the change.

Also, in the first example, the transparent electrode 31 is formed in a spiral form on the diffuser 30. This makes it possible to minimally suppress the decline in transmittance of the diffuser 30 even in comparison to the case where the transparent electrode 31 is formed over the entire surface of the diffuser 30 (FIG. 4) and provide a higher likelihood of detecting breakage of the diffuser 30 at the time of the breakage even in comparison to the case where the transparent electrode 31 is formed in a rectangular form (FIG. 3). Further, in the first example, when the transparent electrode 31 is formed on the diffuser 30, only one terminal is required for connecting the breakage detection section 111.

It should be noted, however, that the transparent electrode 31 formed on the diffuser 30 is not limited in pattern to a spiral form and that a desired form can be used as long as there are no branches or junctions. Also, although the longer the transparent electrode 31 in a spiral form by increasing the number of turns thereof, the higher the accuracy with which the breakage of the diffuser 30 can be detected, the transmittance is adversely affected by as much as the improvement in accuracy. Accordingly, it is necessary to determine the pattern in consideration of these factors.

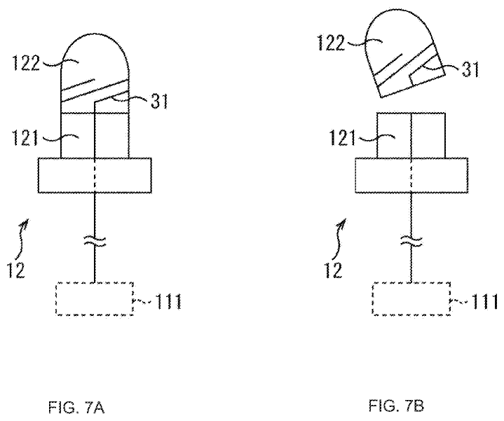

It should be noted that although the diffuser 30 in the shape of a plate is illustrated as an example of a diffusion member in the example of FIG. 5, a diffusion member in other shape may also be used. For example, as illustrated in FIG. 7, the filler-diffusion type light source section 12 using a filler diffusion member 122 having an optical diffusion filler (e.g., titanium oxide) mixed and sealed in its resin for diffusion as a material covering an upper side of a light source 121 such as an LED can similarly detect the breakage of the filler diffusion member 122 having a light diffusion function in the light source section 12.

Specifically, in the light source section 12, the transparent electrode 31 is spirally wound around the filler diffusion member 122. One end thereof is connected to the breakage detection section 111 (FIG. 5) that includes the pulse generator 101, the comparators 102-1 and 102-2, and the determination unit 103. The other end thereof is left open on the filler diffusion member 122 (FIG. 7).

Assumed here is a case where the filler diffusion member 122 makes a transition from a normal state (FIG. 7A) to a broken state (FIG. 7B) in the light source section 12. In this case, the breakage detection section 111 feeds a pulsed wave to the transparent electrode 31 wound around the filler diffusion member 122 and captures a reflected wave from the open end. Accordingly, the temporal position of the reflected wave changes in the event of breakage of the filler diffusion member 122 as illustrated by the timing charts in FIG. 6. As a result, the breakage can be detected by detecting the change.

### 2. Second Embodiment

(Example of Detection of the Diffuser Breakage)

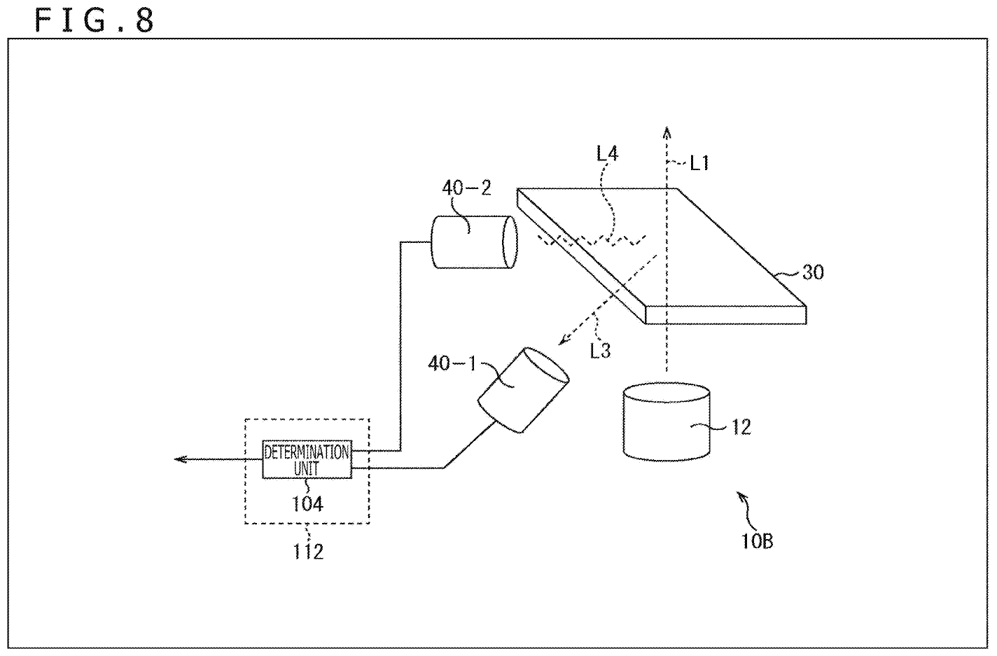

FIG. 8 is a diagram illustrating a second example of detection of diffuser breakage by the distance measurement apparatus to which the technology according to the present disclosure is applied.

In FIG. 8, a distance measurement apparatus 10B has optical detectors 40-1 and 40-2 and a breakage detection section 112 for the diffuser 30. The breakage detection section 112 includes a determination unit 104.

A photodiode, for example, is used as the optical detector 40-1 and provided on the side of the light source section 12 relative to the diffuser 30. The optical detector 40-1 detects a laser beam L1 (irradiated beam L1) irradiated by the light source section 12, a reflected beam L3 reflected by the diffuser 30. The optical detector 40-1 outputs, to the determination unit 104, a detection result of the reflected beam L3 from the diffuser 30.

A photodiode, for example, is used as the optical detector 40-2 and provided in the vicinity around the diffuser 30 (e.g., at an edge of the diffuser 30). The optical detector 40-2 detects the laser beam L1 irradiated by the light source section 12, the laser beam L1 being a scattered light beam L4 inside the diffuser 30. The optical detector 40-2 outputs, to the determination unit 104, a detection result of the reflected beam L4 from the diffuser 30.

The detection result of the reflected beam L3 from the optical detector 40-1 and the detection result of the scattered beam L4 from the optical detector 40-2 are fed to the determination unit 104. Also, data indicating a relationship between the breakage of the diffuser 30 and the change in light intensity (hereinafter also referred to as a breakage/light intensity change table) is stored in advance in the determination unit 104.

The determination unit 104 determines, by using the breakage/light intensity change table, whether or not the change in light intensity indicated by at least one of the reflected beam L3 or the scattered beam L4 exceeds an upper limit or falls below a lower limit, both of the limits being set in advance, i.e., the change is equivalent to that in light intensity at the time of the breakage of the diffuser 30, outputting a determination result thereof.

As described above, in the second example, the optical detectors 40-1 and 40-2 are provided at predetermined positions relative to the diffuser 30. It is possible to reliably detect the breakage of the diffuser 30 by constantly monitoring the change in light intensity obtained by the detection results thereof and detecting the change in light intensity caused by the breakage of the diffuser 30.

Also, in the second example, there is no need to provide any transparent electrode 31 on the diffuser 30, thus allowing for detection of the breakage of the diffuser 30 without adversely affecting the light intensity of the laser beam L1 passing through the diffuser 30. Further, as long as data indicating the relationship between unusual emission of the laser beam L1 and the change in light intensity, for example, is stored in the determination unit 104, it is possible to detect not only the breakage of the diffuser 30 but also unusual emission of the laser beam L1 or other incident.

It should be noted that although described is a case, in the example of FIG. 8, where the optical detector 40-1 is provided on the side of the light source section 12 and the optical detector 40-2 is provided in the vicinity around the diffuser 30, all that is needed, in short, is a detection result indicating a change in light intensity for detecting the breakage of the diffuser 30, and the optical detectors 40 are provided at desired positions. For example, both the optical detectors 40-1 and 40-2 are not necessarily needed, and any one of them may be provided.

Also, although the diffuser 30 in the shape of a plate is illustrated as an example of a diffusion member in the example of FIG. 8 in the example of FIG. 5, a diffusion member in other shape such as that suitable for a filler-diffusion type may also be used.

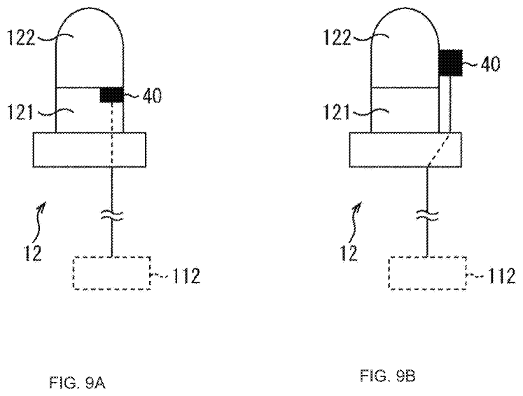

Specifically, for example, it is possible to detect detachment and breakage of the filler diffusion member 122 covering the upper side of the light source 121 such as an LED by providing the optical detector 40 on the filler diffusion member 122 in the light source section 12 as illustrated in FIGS. 9A and 9B and constantly monitoring the change in light intensity obtained from the detection result thereof.

### 3. Third Embodiment

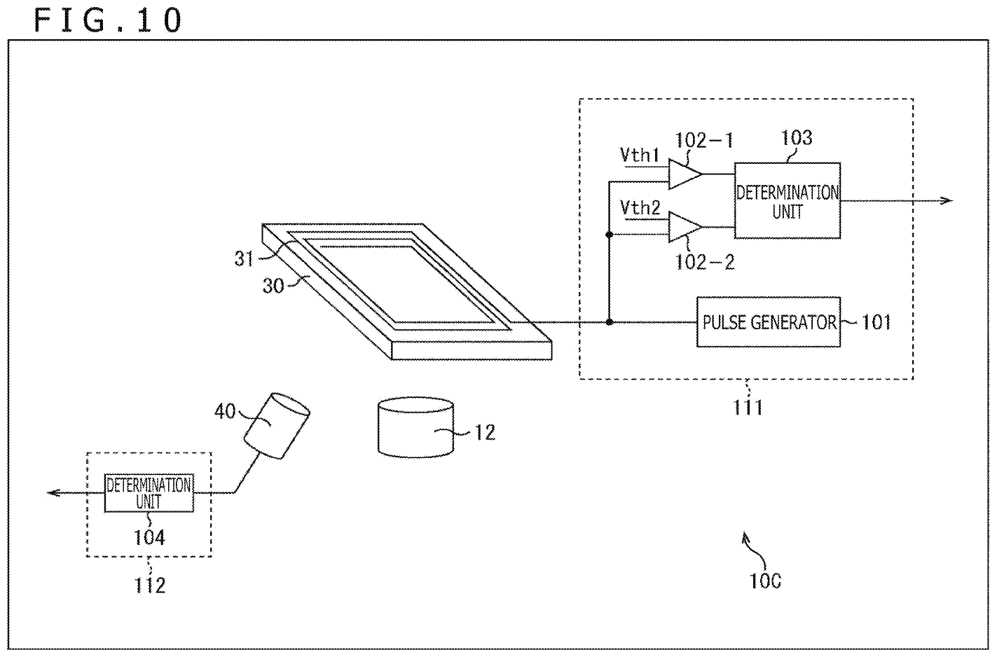

FIG. 10 is a diagram illustrating a third example of detection of diffuser breakage by the distance measurement apparatus to which the technology according to the present disclosure is applied.

In FIG. 10, a distance measurement apparatus 10C has the breakage detection section 111 and the breakage detection section 112 for the diffuser 30. That is, the distance measurement apparatus 10C illustrated in FIG. 10 has the function to detect the breakage of the diffuser 30 available with the distance measurement apparatus 10A (FIG. 5) and the function to detect the breakage of the diffuser 30 available with the distance measurement apparatus 10B (FIG. 8), both described above.

The breakage detection section 111 includes the transparent electrode 31 applied in a spiral form to the diffuser 30, the pulse generator 101, the comparators 102-1 and 102-2, and the determination unit 103. The breakage detection section 111 can detect the breakage of the diffuser 30 by feeding a pulsed wave to the transparent electrode 31 formed on the diffuser 30, capturing a reflected wave from the open end, and detecting the change in the temporal position of the reflected wave.

The breakage detection section 112 includes an optical detector 40 provided at a predetermined position relative to the diffuser 30, and the determination unit 104. The breakage detection section 112 can detect the breakage of the diffuser 30 by detecting the change in light intensity obtained from the detection result by the optical detector 40.

As described above, in the third example, the breakage of the diffuser 30 is detected by two kinds of the detection means, namely, the breakage detection section 111 and the breakage detection section 112. As a result, in the case where the breakage of the diffuser 30 is detected by both kinds of the detection means, it is highly likely that the diffuser 30 is broken, thus suppressing erroneous detection of the breakage and providing improved detection reliability.

Also, even in the case where one kind of the detection means is unable to detect the breakage of the diffuser 30, the other detection means can detect the breakage of the diffuser 30, thus allowing for more reliable detection of the breakage of the diffuser 30.

It should be noted that although the diffuser 30 in the shape of a plate is illustrated as an example of a diffusion member in the example of FIG. 10, a diffusion member in other shape such as that suitable for a filler-diffusion type may also be used.

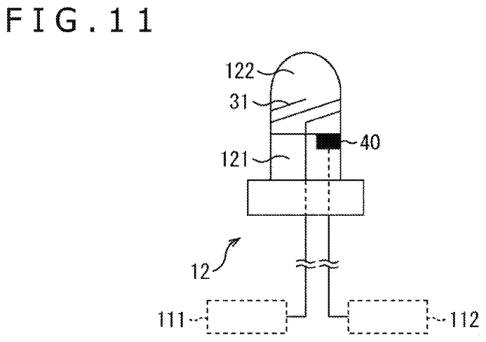

Specifically, for example, it is possible to detect, using two kinds of the detection means, namely, the breakage detection section 111 and the breakage detection section 112, detachment and breakage of the filler diffusion member 122 covering the upper side of the light source 121 such as an LED by wrapping the transparent electrode 31 around the filler diffusion member 122 in a spiral manner and providing the optical detector 40 in the light source section 12 as illustrated in FIG. 11.

### 4. Fourth Embodiment

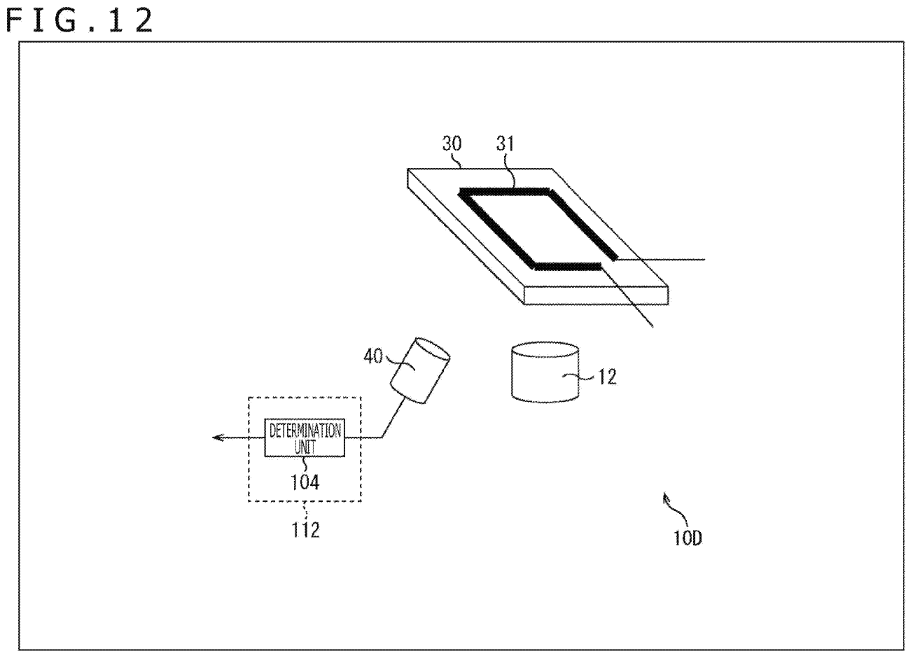

FIG. 12 is a diagram illustrating a fourth example of detection of diffuser breakage by the distance measurement apparatus to which the technology according to the present disclosure is applied.

In FIG. 12, a distance measurement apparatus 10D detects the breakage of the diffuser 30 by detecting the change in resistance or capacitance of the transparent electrode 31 applied in a rectangular form to the surface of the diffuser 30.

Also, the distance measurement apparatus 10D has the optical detector 40 and the breakage detection section 112. The optical detector 40 is provided at a predetermined position relative to the diffuser 30. The breakage detection section 112 includes the determination unit 104. The breakage detection section 112 can detect the breakage of the diffuser 30 by detecting the change in light intensity obtained from the detection result by the optical detector 40.

As described above, while it is possible to suppress a decline in laser beam intensity in the case of the transparent electrode 31 formed in a rectangular form on the diffuser 30, it is impossible to detect the breakage if the breakage occurs in a region other than that where the transparent electrode 31 functions as a detection line. In the fourth example, however, it is possible to detect the breakage even in a region where the transparent electrode 31 does not function as a detection line by providing the breakage detection section 112.

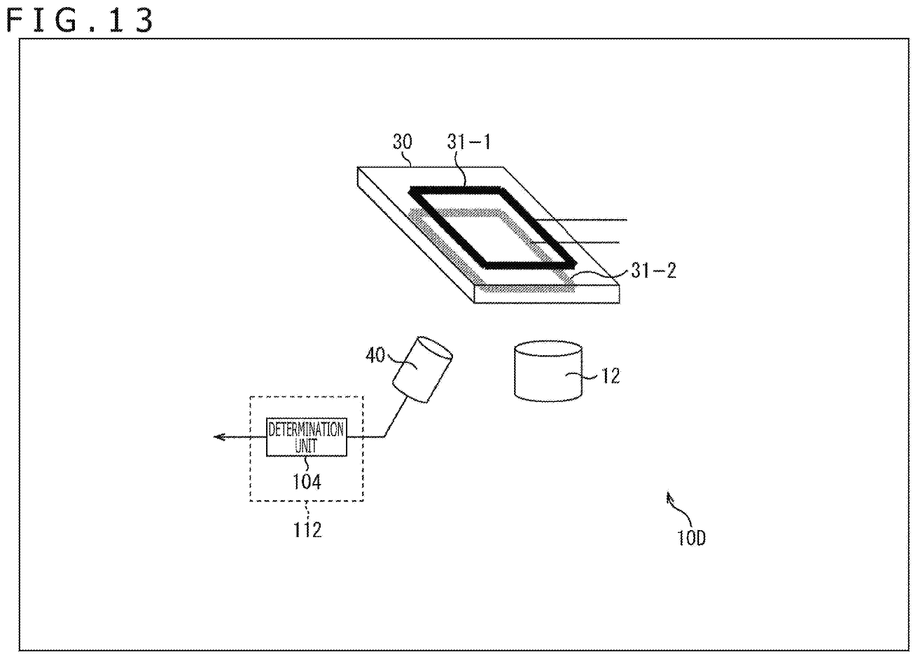

It should be noted that although illustrated is a case where the transparent electrode 31 is applied only to the front side of the diffuser 30 in the distance measurement apparatus 10D depicted in FIG. 12, the breakage of the diffuser 30 may be detected according to the change in light intensity by providing the breakage detection section 112 in the case where the transparent electrodes 31-1 and 31-2 are applied to the front and rear sides of the diffuser 30, respectively, as in the distance measurement apparatus 10D depicted in FIG. 13.

Also, in the examples illustrated in FIGS. 12 and 13, although the diffuser 30 in the shape of a plate is illustrated as an example of a diffusion member in the examples of FIGS. 12 and 13, a diffusion member in other shape such as that suitable for a filler-diffusion type may also be used.

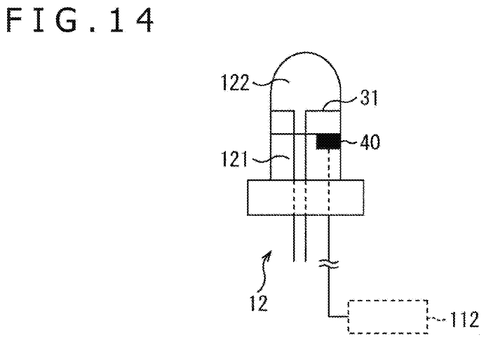

Specifically, for example, it is possible to detect the detachment and breakage of the filler diffusion member 122 covering the upper side of the light source 121 such as an LED by wrapping the transparent electrode 31 around the filler diffusion member 122, providing the optical detector 40, and constantly monitoring the change in light intensity obtained by the detection result thereof in the light source section 12 as illustrated in FIG. 14.

### 5. Fifth Embodiment

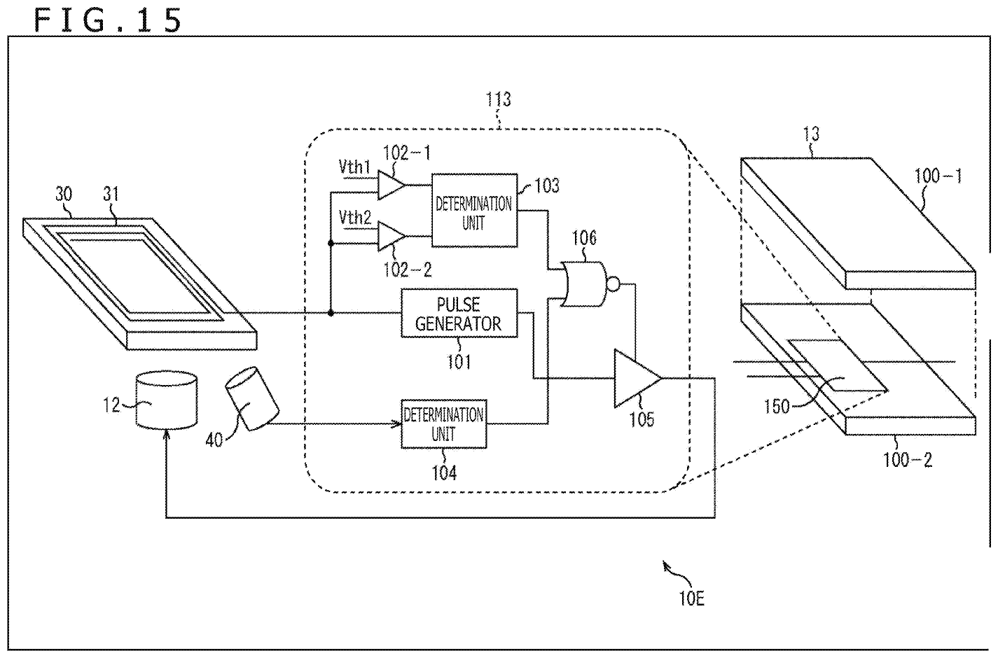

FIG. 15 is a diagram illustrating a fifth example of detection of diffuser breakage by the distance measurement apparatus to which the technology according to the present disclosure is applied.

In FIG. 15, a distance measurement apparatus 10E has a laminated structure with first and second layers, the first layer 100-1 including the sensor section 13 and the second layer 100-2 including a circuit section 150, and the first and second layers are stacked one on top of another. The circuit section 150 includes a breakage detection section 113. The breakage detection section 113 includes the functions of both the breakage detection section 111 (FIG. 5) and the breakage detection section 112 (FIG. 8) described above.

The breakage detection section 113 includes the pulse generator 101, the comparators 102-1 and 102-2, the determination unit 103, the determination unit 104, a light source driver 105, and a logic circuit 106. The pulse generator 101, the comparators 102-1 and 102-2, the determination unit 103 are provided for the transparent electrode 31 applied in a spiral form to the diffuser 30. The determination unit 104 is provided for the optical detector 40 that is provided at a predetermined position relative to the diffuser 30.

The pulse generator 101 generates a rectangular pulsed wave (pulsed signal), outputting the rectangular pulsed wave to the light source driver 105. The light source driver 105 drives the light source section 12 on the basis of the pulsed signal fed from the pulse generator 101.

As a result, the light source section 12 emits a modulated light beam (rectangular pulsed beam), a laser beam modulated by the rectangular pulsed wave. Then, the laser beam (modulated beam) emitted from the light source section 12 is diffused by the diffuser 30 and irradiated to the target object 20 (FIG. 2), after which a reflected beam thereof enters the sensor section 13.

Also, the pulse generator 101 feeds the generated rectangular pulsed wave to the transparent electrode 31 connected thereto. When fed to the transparent electrode 31, this rectangular pulsed wave is reflected at the open end, thus causing a reflected wave thereof to be captured by the comparators 102-1 and 102-2.

The comparators 102-1 and 102-2 compare the voltage levels of the input signals fed thereto with the reference voltages Vth1 and Vth2, respectively. These comparison results are determined by the determination unit 103, thus allowing for detection of the change in temporal position of the reflected wave and detection of the breakage of the diffuser 30. The determination result by the determination unit 103 is output to the logic circuit 106.

It should be noted that the actions of the comparators 102-1 and 102-2 and the determination unit 103 are similar to those described with reference to FIGS. 5 and 6. Accordingly, a detailed description thereof will be omitted here.

The detection result of the reflected beam from the optical detector 40 is fed to the determination unit 104. The determination unit 104 determines, by using the breakage/light intensity change table, whether or not the change in light intensity of the reflected beam is equivalent to the change in light intensity at the time of the breakage of the diffuser 30, thus allowing for detection of the breakage of the diffuser 30. The detection result by the determination unit 104 is output to the logic circuit 106.

It should be noted that the action of the determination unit 104 is similar to that described with reference to FIG. 8. Accordingly, a detailed description thereof will be omitted here.

The detection result from the determination unit 103 and the detection result from the determination unit 104 are fed to the logic circuit 106. The logic circuit 106 is configured, for example, as a negative OR logic gate (NOT gate). In the case where at least one of the determination results from the determination units 103 and 104 indicates that the diffuser 30 is broken, the logic circuit 106 outputs a signal to that effect (e.g., L-level signal) to the light source driver 105.

When the signal from the logic circuit 106 indicates that the diffuser 30 is broken, the light source driver 105 stops driving the light source section 12. This allows for the distance measurement apparatus 10E to halt the emission of the laser beam (modulated beam) from the light source section 12 when the diffuser 30 breaks.

As described above, although the distance measurement apparatus 10E based on the indirect technique has the pulse generator 101 for modulating a laser beam emitted from the light source section 12 with a rectangular pulsed wave or other type of signal, the breakage of the diffuser 30 is detected by using a rectangular pulsed wave generated by the pulse generator 101 in the fifth example. This contributes to reduced cost for providing the breakage detection section 113 in the distance measurement apparatus 10E.

Also, in the fifth example, the breakage detection section 113 detects the breakage of the diffuser 30 by using two kinds of detection means (detection methods) corresponding to the breakage detection section 111 (FIG. 5) and the breakage detection section 112 (FIG. 8) described above, thus allowing for reliable detection of the diffuser 30 and reliable halting of the emission of a laser beam from the light source section 12 at the time of the breakage of the diffuser 30. This makes it possible to protect users from the laser beam (e.g., prevent a laser beam from the light source section 12 from directly entering user's eyes at the time of the breakage of the diffuser 30), for example, in the case where the diffuser 30 breaks as a result of the fall of the distance measurement apparatus 10E or for other cause.

Also, when the breakage detection section 113 is installed in the distance measurement apparatus 10E, it is only necessary to connect a total of three signal lines, i.e., one signal line (detection line) from the transparent electrode 31 formed on the diffuser 30, another signal line (detection line) from the optical detector 40, and still another signal line (control line) for driving (controlling) the light source section 12, thus providing a simpler configuration.

Further, it is possible to keep the increase in chip size to a minimum by using the distance measurement apparatus 10E having a laminated structure with a first layer 100-1 and a second layer 100-2. The first layer includes the sensor section 13, and the second layer 100-2 includes the circuit section 150 having with the breakage detection section 113 (including the light source driver 105 and the logic circuit 106), and the first layer 100-1 and the second layer 100-2 are stacked one on top of another.

It should be noted that although the diffuser 30 in the shape of a plate is illustrated as an example of a diffusion member in the example of FIG. 15, a diffusion member in other shape such as that suitable for a filler-diffusion type may also be used.

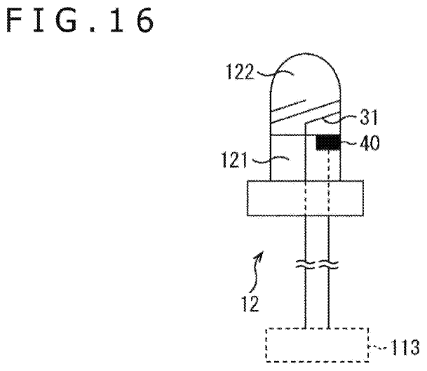

Specifically, for example, it is possible to detect detachment and breakage of the filler diffusion member 122 covering the upper side of the light source 121 such as an LED by wrapping the transparent electrode 31 around the filler diffusion member 122 in a spiral manner and providing the optical detector 40 in the light source section 12 and constantly monitoring the change in light intensity obtained from the detection result thereof as illustrated in FIG. 16.

Also, although illustrated is a case, in the example of FIG. 15, where the breakage of the diffuser 30 is detected by two kinds of detection means equivalent to the breakage detection section 111 (FIG. 5) and the breakage detection section 112 (FIG. 8) described above, it is similarly possible to halt the emission of a laser beam from the light source section 12 when the breakage of the diffuser 30 is detected even in the case where only one kind of the detection means is installed.

### 6. Modification Example

Although a description is given above of the distance measurement apparatus 10 as equipment having a light source section that emits a laser beam, the technology according to the present disclosure is applicable not only to the distance measurement apparatus 10 but also to equipment in general that handles laser beams. That is, the technology according to the present disclosure is applicable, for example, to a laser apparatus that emits a laser beam.

### 7. Configuration Example of Electronic Equipment

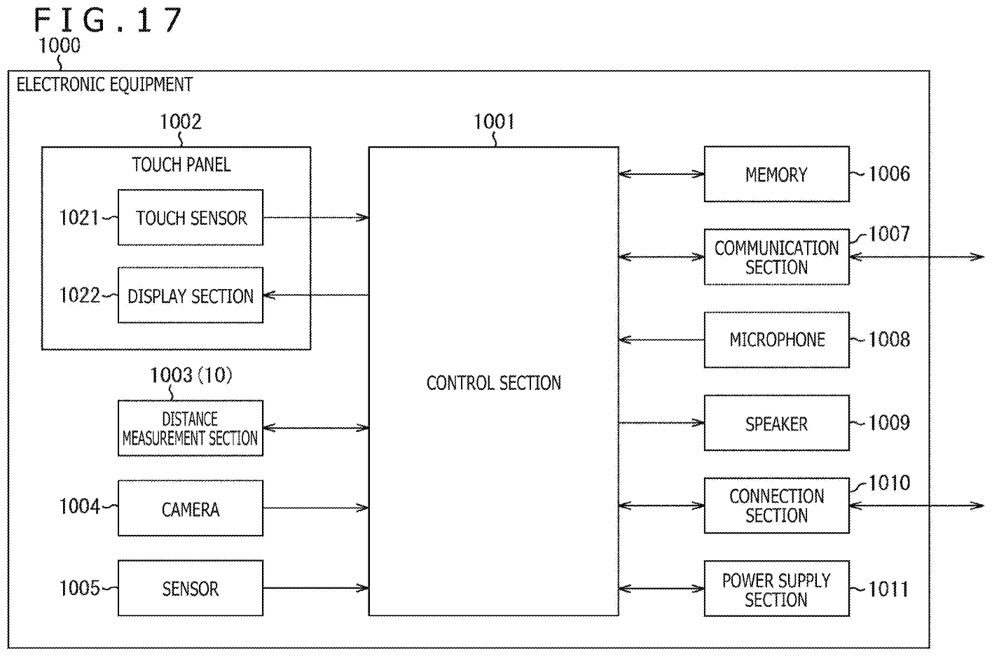

FIG. 17 is a block diagram illustrating a configuration example of electronic equipment having a distance measurement apparatus to which the technology according to the present disclosure is applied.

Electronic equipment 1000 illustrated in FIG. 17 is configured, for example, as a smartphone or mobile phone, a tablet terminal, a mobile terminal such as gaming console, a watch-type or goggle-type wearable terminal, or the like.

In FIG. 17, the electronic equipment 1000 includes a control section 1001, a touch panel 1002, a distance measurement section 1003, a camera 1004, a sensor 1005, a memory 1006, a communication section 1007, a microphone 1008, a speaker 1009, a connection section 1010, and a power supply section 1011.

The control section 1001 includes, for example, a CPU (Central Processing Unit), a microprocessor, an FPGA (Field Programmable Gate Array), or the like. The control section 1001 functions as a key processing apparatus of the electronic equipment 1000, handling various computations and controlling actions of each section.

The touch panel 1002 includes a touch sensor 1021 and a display section 1022. Here, the touch sensor 1021 is disposed over a screen of the display section 1022.

The touch sensor 1021 detects an input operation (e.g., tapping or flicking) made on the touch panel 1002 by the user together with the position of the touch panel 1002 where the operation is made, supplying a detection signal thereof to the control section 1001. The display section 1022 includes, for example, a liquid crystal display, an organic EL display, or other type of display. The display section 1022 displays various types of information such as text, images, videos, and the like under control of the control section 1001.

The distance measurement section 1003 is configured to suit the distance measurement apparatus 10 illustrated in FIG. 1. The distance measurement section 1003 performs distance measurement actions under control of the control section 1001, outputting data regarding distance information (distance image) obtained as a result thereof.

The camera 1004 includes an image sensor such as a CMOS (Complementary Metal Oxide Semiconductor) image sensor or a CCD (Charge Coupled Device) image sensor and a signal processing section such as a camera ISP (Image Signal Processor).

The camera 1004 performs, on the signal obtained as a result of capture of a subject by the image sensor, not only processes for correcting optics such as lenses and processes for dealing with variation between image sensors but also processes associated with exposure, focus, white balance, and the like, supplying captured image data, obtained as a result thereof, to the control section 1001.

The sensor 1005 includes various types of sensors. The sensor 1005 performs sensing to obtain a variety of information regarding the user and his or her surrounding environment, supplying sensor data corresponding to the sensing result to the control section 1001.

For example, the sensor 1005 can include a variety of types of sensors such as an environmental light sensor that detects brightness of the surrounding environment, a biosensor that detects biological information such as fingerprints, irises, and pulses, a magnetic sensor that detects a magnitude and a direction of a magnetic field, an acceleration sensor that detects acceleration, a gyro sensor that detects an angle (posture), an angular velocity, and angular acceleration, and a proximity sensor that detects an object in proximity.

The memory 1006 includes, for example, a semiconductor memory such as a non-volatile memory (e.g., NVRAM (Non-Volatile RAM)). The memory 1006 stores various types of data under control of the control section 1001.

The communication section 1007 includes, for example, a communication module that supports cellular communication (e.g., LTE-Advanced and 5G) or wireless communication such as a wireless LAN (Local Area Network). The communication section 1007 exchanges various types of data with various types of servers via networks such as the Internet under control of the control section 1001.

The microphone 1008 is a piece of equipment (sound collector) that converts external sound (audio) into an electric signal. The microphone 1008 supplies an audio signal, obtained as a result of the conversion, to the control section 1001. The speaker 1009 outputs a sound (audio) corresponding to the electric signal such as audio signal under control of the control section 1001.

The connection section 1010 includes an input/output interface circuit that supports a predetermined communication scheme and inputs or outputs data exchanged between the control section 1001 and external apparatuses. The power supply section 1011 supplies source power, obtained from a storage battery or external power supply, to different sections of the electronic equipment 1000 including the control section 1001 under control of the control section 1001.

The electronic equipment 1000 configured as described above has a variety of functions one of which is to generate distance information (distance image) through a distance measurement action of the distance measurement section 1003 (distance measurement apparatus 10). Also, there is a possibility that the diffuser 30 of the distance measurement section 1003 (distance measurement apparatus 10) may break, for example, in the case where the user drops the electronic equipment 1000 such as a smartphone. The distance measurement section 1003 (distance measurement apparatus 10) to which the technology according to the present disclosure is applied reliably detects the breakage of the diffuser 30 and halts the emission of a laser beam from the light source section 12.

### 8. Example of Application to Mobile Object

The technology according to the present disclosure (present technology) is applicable to a variety of products. For example, the technology according to the present disclosure may be realized as an apparatus mounted to one type of mobile object among an automobile, an electric vehicle, a hybrid electric vehicle, a motorcycle, a bicycle, a personal mobility, an airplane, a drone, a ship, a robot, and the like.

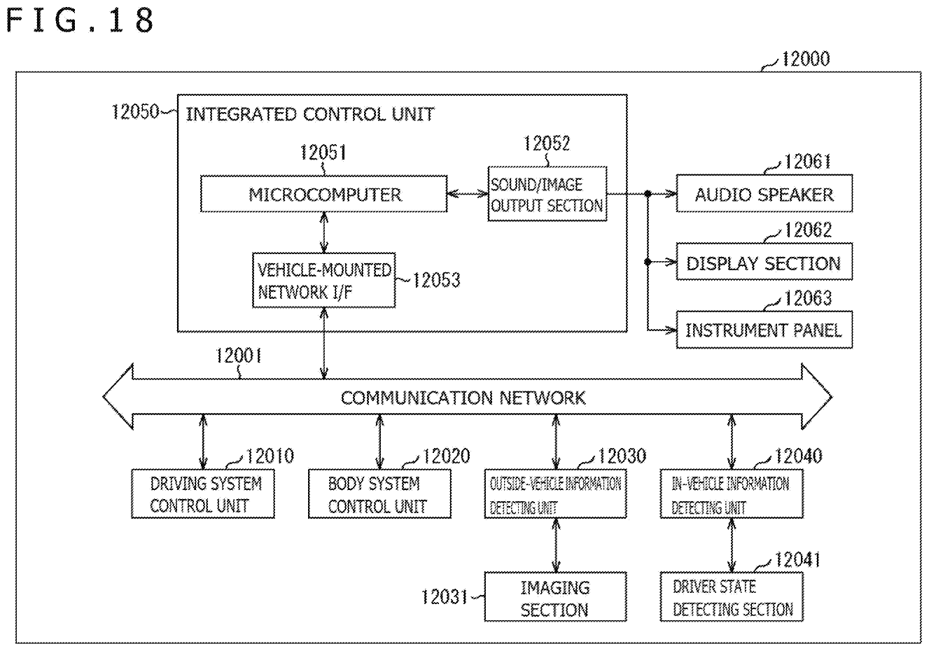

FIG. 18 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 18, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display and a head-up display.

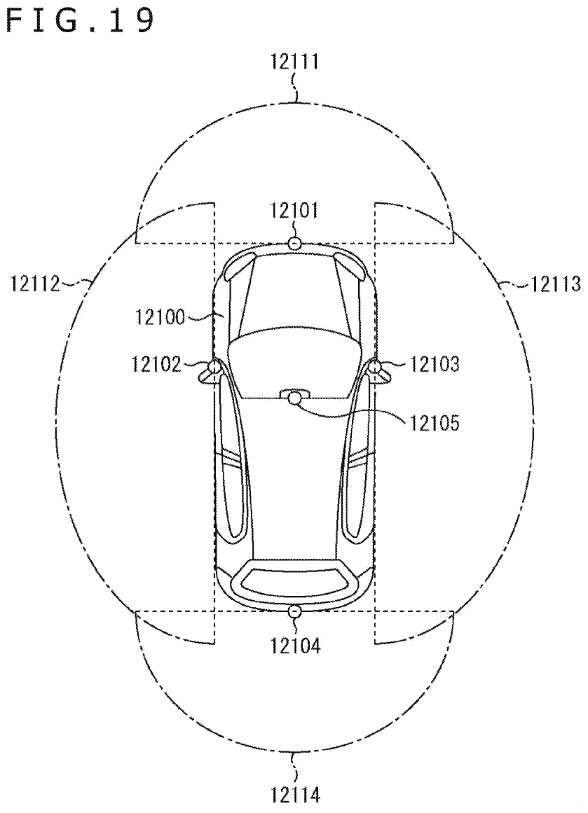

FIG. 19 is a diagram depicting an example of the installation position of the imaging section 12031.

In FIG. 19, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of a vehicle control system to which the technology according to the present disclosure is applicable has been described above. The technology according to the present disclosure is applicable, of the components described above, to the imaging section 12031. Specifically, the distance measurement apparatus 10 is applicable to the imaging section 12031. The application of the technology according to the present disclosure to the imaging section 12031 allows, against the backdrop of a possibility that the diffuser 30 of the distance measurement apparatus 10 may break under some sort of impact in the vehicle, for reliable detection of the breakage and halting of the emission of a laser beam from the light source section 12, thus protecting the user.

It should be noted that embodiments of the present technology are not limited to those described above and can be modified in various ways without departing from the gist of the present technology.

It should be noted that the present technology can also have the following configurations.

(1)

A distance measurement apparatus including:

a light source section adapted to emit a laser beam; and

a breakage detection section adapted to detect breakage of a diffusion member that diffuses the laser beam emitted from the light source section, in which

the light source section modulates the laser beam on the basis of a pulsed wave generated by a pulse generator and emits the modulated laser beam, and

the breakage detection section feeds the pulsed wave to one end of a transparent electrode formed in a predetermined pattern on the diffusion member, detects a reflected wave that occurs at a released end that is another end, and detects breakage of the diffusion member on the basis of a detection result of the reflected wave.

(2)

The distance measurement apparatus according to (1), in which

the light source section halts emission of the laser beam in the case where the breakage of the diffusion member is detected by the breakage detection section.

(3)

The distance measurement apparatus according to (1) or (2), in which

the breakage detection section includes
a first comparator adapted to compare a voltage level of an input signal with a first reference voltage set between a voltage level of the pulsed wave and a voltage level of the reflected wave,
a second comparator adapted to compare the voltage level of the input signal with a second reference voltage set equal to or less than the voltage level of the reflected wave, and
a first determination unit adapted to determine that the diffusion member is broken in the case where a time difference between falling edges of the input signals compared is equal to or less than a predetermined threshold on the basis of the comparison results by the first and second comparators.
   (4)

The distance measurement apparatus according to any one of (1) to (3), further including:

an optical detector provided at a predetermined position relative to the diffusion member and adapted to detect the laser beam that has passed through the diffusion member, in which

the breakage detection section detects the breakage of the diffusion member on the basis of a detection result by the optical detector.

(5)

The distance measurement apparatus according to (4), in which

the breakage detection section includes
a second determination unit adapted to determine that the diffusion member is broken in the case where a light intensity detected by the optical detector exceeds an upper limit or falls below a lower limit, both of the limits being set in advance.
   (6)

The distance measurement apparatus according to (4) or (5), in which

the light source section halts emission of the laser beam in the case where the breakage detection section detects the breakage of the diffusion member on the basis of at least one of the detection result of the reflected wave or the detection result by the optical detector.

(7)

The distance measurement apparatus according to any one of (1) to (6), in which

the diffusion member is configured as a diffuser or a filler diffusion member used for the filler-diffusion type light source section.

(8)

The distance measurement apparatus according to any one of (1) to (7) further including:

a sensor section adapted to detect the laser beam emitted from the light source section, the laser beam being a reflected beam reflected by a target object, in which

the distance measurement apparatus is configured as a distance image sensor based on a TOF (Time Of Flight) technique that adopts an indirect technique.

(9)

The distance measurement apparatus according to (8) including:

a laminated structure with a first layer including the sensor section and a second layer including a circuit section having the breakage detection section stacked one on top of another.

(10)

A detection method by a distance measurement apparatus including a light source section that emits a laser beam, the detection method including:

feeding a pulsed wave generated by a pulse generator and used by the light source section to modulate the laser beam, to one end of a transparent electrode formed in a predetermined pattern on a diffusion member that diffuses the laser beam emitted from the light source section;

detecting a reflected wave that occurs at a released end that is another end; and

detecting breakage of the diffusion member on the basis of a detection result of the reflected wave.

(11)

A distance measurement apparatus including:

a light source section adapted to emit a laser beam; and

a breakage detection section adapted to detect breakage of a diffusion member that diffuses the laser beam emitted from the light source section, in which

the breakage detection section feeds a pulsed wave generated by a pulse generator, to one end of a transparent electrode formed in a predetermined pattern on the diffusion member, detects a reflected wave that occurs at a released end that is another end, and detects breakage of the diffusion member on the basis of a detection result of the reflected wave.

(12)

The distance measurement apparatus according to (11), in which

the breakage detection section includes
a first comparator adapted to compare a voltage level of an input signal with a first reference voltage set between a voltage level of the pulsed wave and a voltage level of the reflected wave,
a second comparator adapted to compare the voltage level of the input signal with a second reference voltage set equal to or less than the voltage level of the reflected wave, and
a determination unit adapted to determine that the diffusion member is broken in the case where a time difference between falling edges of the input signals compared is equal to or less than a predetermined threshold on the basis of the comparison results by the first and second comparators.
   (13)

The distance measurement apparatus according to (11) or (12), in which

the pattern is formed by applying the linear transparent electrode in a spiral form to the diffusion member.

(14)

The distance measurement apparatus according to any one of (11) to (13), in which

the diffusion member is configured as a diffuser or a filler diffusion member used for the filler-diffusion type light source section.

(15)

A detection method by a distance measurement apparatus including a light source section that emits a laser beam, the detection method including:

feeding a pulsed wave generated by a pulse generator, to one end of a transparent electrode formed in a predetermined pattern on a diffusion member that diffuses the laser beam emitted from the light source section;

detecting a reflected wave that occurs at a released end that is another end; and

detecting breakage of the diffusion member on the basis of a detection result of the reflected wave.

(16)

A distance measurement apparatus including:

a light source section adapted to emit a laser beam;

an optical detector provided at a predetermined position relative to a diffusion member that diffuses the laser beam emitted from the light source section and adapted to detect the laser beam that has passed through the diffusion member; and

a breakage detection section adapted to detect breakage of the diffusion member on the basis of a detection result by the optical detector.

(17)

The distance measurement apparatus according to (16), in which

the breakage detection section includes
a determination unit adapted to determine that the diffusion member is broken in the case where a light intensity detected by the optical detector exceeds an upper limit or falls below a lower limit, both of the limits being set in advance.
   (18)

The distance measurement apparatus according to (16) or (17), in which

the optical detector is provided at at least one of a position on the side of the light source section relative to the diffusion member or another position in the vicinity around the diffusion member.

(19)

The distance measurement apparatus according to any one of (16) to (18), in which

the diffusion member is configured as a diffuser or a filler diffusion member used for the filler-diffusion type light source section.

(20)

A detection method by a distance measurement apparatus including a light source section that emits a laser beam, the detection method including:

detecting breakage of a diffusion member on the basis of a detection result by an optical detector provided at a predetermined position relative to the diffusion member that diffuses the laser beam emitted from the light source section to detect the laser beam that has passed through the diffusion member.

### REFERENCE SIGNS LIST

10, 10A, 10B, 10C, 10D, 10E: Distance measurement apparatus
11: Control section
12: Light source section
13: Sensor section
20: Target object
30: Diffuser
40, 40-1, 40-2: Optical detector
31: Transparent electrode
100-1: First layer
100-2: Second layer
101: Pulse generator
102-1: Comparator
102-2: Comparator
103: Determination unit
104: Determination unit
105: Light source driver
106: Logic circuit
111: Breakage detection section
112: Breakage detection section
113: Breakage detection section
121: Light source
122: Filler diffusion member
150: Circuit section
1000: Electronic equipment
1001: Control section
1003: Distance measurement section

1. A distance measurement apparatus comprising:
a light source section adapted to emit a laser beam; and
a breakage detection section adapted to detect breakage of a diffusion member that diffuses the laser beam emitted from the light source section, wherein
the light source section modulates the laser beam on a basis of a pulsed wave generated by a pulse generator and emits the modulated laser beam, and
the breakage detection section feeds the pulsed wave to one end of a transparent electrode formed in a predetermined pattern on the diffusion member, detects a reflected wave that occurs at a released end that is another end, and detects breakage of the diffusion member on a basis of a detection result of the reflected wave.

2. The distance measurement apparatus according to claim 1, wherein
the light source section halts emission of the laser beam in a case where the breakage of the diffusion member is detected by the breakage detection section.

3. The distance measurement apparatus according to claim 1, wherein
the breakage detection section includes
a first comparator adapted to compare a voltage level of an input signal with a first reference voltage set between a voltage level of the pulsed wave and a voltage level of the reflected wave,
a second comparator adapted to compare the voltage level of the input signal with a second reference voltage set equal to or less than the voltage level of the reflected wave, and
a first determination unit adapted to determine that the diffusion member is broken in a case where a time difference between falling edges of the input signals compared is equal to or less than a predetermined threshold on a basis of the comparison results by the first and second comparators.

4. The distance measurement apparatus according to claim 1, further comprising:
an optical detector provided at a predetermined position relative to the diffusion member and adapted to detect the laser beam that has passed through the diffusion member, wherein
the breakage detection section detects the breakage of the diffusion member on a basis of a detection result by the optical detector.

5. The distance measurement apparatus according to claim 4, wherein
the breakage detection section includes
a second determination unit adapted to determine that the diffusion member is broken in a case where a light intensity detected by the optical detector exceeds an upper limit or falls below a lower limit, both of the limits being set in advance.

6. The distance measurement apparatus according to claim 4, wherein
the light source section halts emission of the laser beam in a case where the breakage detection section detects the breakage of the diffusion member on a basis of at least one of the detection result of the reflected wave or the detection result by the optical detector.

7. The distance measurement apparatus according to claim 1, wherein
the diffusion member is configured as a diffuser or a filler diffusion member used for the filler-diffusion type light source section.

8. The distance measurement apparatus according to claim 1, further comprising:
a sensor section adapted to detect the laser beam emitted from the light source section, the laser beam being a reflected beam reflected by a target object, wherein
the distance measurement apparatus is configured as a distance image sensor based on a TOF (Time Of Flight) technique that adopts an indirect technique.

9. The distance measurement apparatus according to claim 8 comprising:
a laminated structure with a first layer including the sensor section and a second layer including a circuit section having the breakage detection section stacked one on top of another.

10. A detection method by a distance measurement apparatus including a light source section that emits a laser beam, the detection method comprising:
feeding a pulsed wave generated by a pulse generator and used by the light source section to modulate the laser beam, to one end of a transparent electrode formed in a predetermined pattern on a diffusion member that diffuses the laser beam emitted from the light source section;
detecting a reflected wave that occurs at a released end that is another end; and
detecting breakage of the diffusion member on a basis of a detection result of the reflected wave.

11. A distance measurement apparatus comprising:
a light source section adapted to emit a laser beam; and
a breakage detection section adapted to detect breakage of a diffusion member that diffuses the laser beam emitted from the light source section, wherein
the breakage detection section feeds a pulsed wave generated by a pulse generator, to one end of a transparent electrode formed in a predetermined pattern on the diffusion member, detects a reflected wave that occurs at a released end that is another end, and detects breakage of the diffusion member on a basis of a detection result of the reflected wave.

12. The distance measurement apparatus according to claim 11, wherein
the breakage detection section includes
a first comparator adapted to compare a voltage level of an input signal with a first reference voltage set between a voltage level of the pulsed wave and a voltage level of the reflected wave,
a second comparator adapted to compare the voltage level of the input signal with a second reference voltage set equal to or less than the voltage level of the reflected wave, and
a determination unit adapted to determine that the diffusion member is broken in a case where a time difference between falling edges of the input signals compared is equal to or less than a predetermined threshold on a basis of the comparison results by the first and second comparators.

13. The distance measurement apparatus according to claim 11, wherein
the pattern is formed by applying the linear transparent electrode in a spiral form to the diffusion member.

14. The distance measurement apparatus according to claim 11, wherein
the diffusion member is configured as a diffuser or a filler diffusion member used for the filler-diffusion type light source section.

15. A detection method by a distance measurement apparatus including a light source section that emits a laser beam, the detection method comprising:
feeding a pulsed wave generated by a pulse generator, to one end of a transparent electrode formed in a predetermined pattern on a diffusion member that diffuses the laser beam emitted from the light source section;
detecting a reflected wave that occurs at a released end that is another end; and
detecting breakage of the diffusion member on a basis of a detection result of the reflected wave.

16. A distance measurement apparatus comprising:
a light source section adapted to emit a laser beam;
an optical detector provided at a predetermined position relative to a diffusion member that diffuses the laser beam emitted from the light source section and adapted to detect the laser beam that has passed through the diffusion member; and
a breakage detection section adapted to detect breakage of the diffusion member on a basis of a detection result by the optical detector.

17. The distance measurement apparatus according to claim 16, wherein
the breakage detection section includes
a determination unit adapted to determine that the diffusion member is broken in a case where a light intensity detected by the optical detector exceeds an upper limit or falls below a lower limit, both of the limits being set in advance.

18. The distance measurement apparatus according to claim 16, wherein
the optical detector is provided at at least one of a position on a side of the light source section relative to the diffusion member or another position in a vicinity around the diffusion member.

19. The distance measurement apparatus according to claim 16, wherein
the diffusion member is configured as a diffuser or a filler diffusion member used for the filler-diffusion type light source section.

20. A detection method by a distance measurement apparatus including a light source section that emits a laser beam, the detection method comprising:
detecting breakage of a diffusion member on a basis of a detection result by an optical detector provided at a predetermined position relative to the diffusion member that diffuses the laser beam emitted from the light source section to detect the laser beam that has passed through the diffusion member.
